(19) United States
(12) Patent Application Publication
(10) Pub. No.: US 2026/0122384 A1
(43) Pub. Date: Apr. 30, 2026

(54) METHOD FOR CONFIGURING DEVICES IN DPOE SYSTEM

(71) Applicant: Hitron Technologies Inc., Hsinchu (TW)

(72) Inventors: Chuxin LI, Hsinchu (TW); Ming JIANG, Hsinchu (TW); Wei LIU, Hsinchu (TW)

(21) Appl. No.: 19/060,420

(22) Filed: Feb. 21, 2025

(30) Foreign Application Priority Data
Oct. 29, 2024 (CN) 202411517351.X

(51) Int. Cl. H04Q 11/00; H04L 12/28; H04L 41/0806

(52) U.S. Cl. CPC H04Q 11/0067; H04L 41/0806; H04L 12/2801; H04Q 2011/0079; H04Q 2213/13543

(57) ABSTRACT

A method for configuring devices in a DPoE system is implemented by a file conversion server, and includes: after receiving a configuration request from a modem module, selecting a target user ID group based on the configuration request; sending a file request that includes the target user ID group to a configuration file server, so as to receive at least one target configuration file; converting the at least one target configuration file into an integrated configuration file, and sending the integrated configuration file to the modem module, the modem module, in response to receipt of the integrated configuration file, converting a format of the integrated configuration file to obtain a converted configuration file, and then sending the converted configuration file to a target MDU for the target MDU to configure, based on the converted configuration file, at least one CPE that is associated with the target MDU.

### CROSS-REFERENCE TO RELATED APPLICATION

This application claims priority to Chinese Invention patent application No. 202411517351.X, filed on Oct. 29, 2024, the entire disclosure of which is incorporated by reference herein.

### FIELD

The disclosure relates to a method for configuring network devices, and more particularly to a method for configuring devices in a DOCSIS (Data Over Cable Service Interface Specification) Provisioning of EPON (Ethernet Passive Optical Network) (DPoE) system.

### BACKGROUND

A DOCSIS (Data Over Cable Service Interface Specification) Provisioning of EPON (Ethernet Passive Optical Network) (DPoE) system, is commonly used by cable operators as a long-term optical access solution. The DPoE system includes a configuration file server, an optical line terminal (OLT) that includes a virtual cable modem (VCM), an optical network unit (ONU), and a customer premise equipment (CPE) that is connected to the ONU.

Conventionally, to configure the CPE in the DPoE system, the configuration file server first obtains a configuration file based on a unique media access control (MAC) address of the ONU, and sends the configuration file to the VCM of the OLT. Then, the VCM converts a format of the configuration file using an operations, administration, and maintenance (OAM) command to obtain a converted configuration file and sends the converted configuration file to the ONU. The ONU then configures the CPE based on the converted configuration file. However, the configuration file server can only obtain a single configuration file that corresponds to the unique MAC address of the ONU for configuring a single CPE associated with the ONU, and is unable to configure multiple CPEs simultaneously, which is inconvenient.

### SUMMARY

Therefore, an object of the disclosure is to provide a method, a file conversion server and a multi-dwelling unit (MDU) for configuring devices in a DPoE system that can alleviate at least one of the drawbacks of the prior art.

According to an aspect of the disclosure, a method for configuring devices in a DPoE system is to be implemented by a file conversion server. The conversion server stores a plurality of household identifications (IDs) corresponding respectively to a plurality of multi-dwelling units (MDUs), and a plurality of user ID groups related respectively to the household IDs. Each of the user ID groups includes at least one user ID that corresponds to a customer premise equipment (CPE) which is associated with one of the MDUs. The method includes: in response to receiving, from a modem module, a configuration request that includes a target household ID corresponding to a target MDU from among the MDUs, selecting, from among the user ID groups, a target user ID group that is related to one of the household IDs which conforms with the target household ID; sending a file request that includes the target user ID group to a configuration file server, where the configuration file server, in response to receipt of the file request, obtains and sends at least one target configuration file that corresponds respectively to the at least one user ID included in the target user ID group to the file conversion server; and in response to receiving the at least one target configuration file from the configuration file server, converting the at least one target configuration file into an integrated configuration file that is associated with the target MDU and that includes a content of the at least one target configuration file, and sending the integrated configuration file to the modem module, the modem module, in response to receipt of the integrated configuration file, converting a format of the integrated configuration file to obtain a converted configuration file, where a content of the converted configuration file includes the content of the at least one target configuration file in a different format, and then sending the converted configuration file to the target MDU for the target MDU to configure, based on at least one target configuration portion of the content of the converted configuration file, at least one CPE that is associated with the target MDU.

According to another aspect of the disclosure, a method for configuring devices in a DPoE system is to be implemented by a multi-dwelling unit (MDU). The method includes: sending a registration request that includes a target household identification (ID) corresponding to the MDU to an optical line terminal (OLT), a modem module of the OLT, in response to receipt of the registration request, sending a configuration request that includes the target household ID to a file conversion server, such that the file conversion server obtains, from a configuration file server, at least one target configuration file according to a target user ID group that is related to the target household ID and that includes at least one user ID corresponding respectively to the at least one target configuration file, and sends an integrated configuration file that includes a content of the at least one target configuration file to modem module, the modem module further, in response to receipt of the integrated configuration file, converting a format of the integrated configuration file to obtain a converted configuration file, where a content of the converted configuration file includes the content of the at least one target configuration file in a different format, and then sending the converted configuration file to the MDU; and in response to receiving the converted configuration file, configuring, based on at least one target configuration portion of the content of the converted configuration file, at least one customer premise equipment that is associated with the MDU.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating a DPoE system that implements a method for configuring devices according to an embodiment of the disclosure.

FIG. 2 is a flow chart illustrating the method for configuring devices in a DPoE system according to an embodiment of the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

Throughout the disclosure, the term “coupled to” or “connected to” may refer to a direct connection among a plurality of electrical apparatus/devices/equipment via an electrically conductive material (e.g., an electrical wire), or an indirect connection between two electrical apparatus/devices/equipment via another one or more apparatus/devices/equipment, or wireless communication.

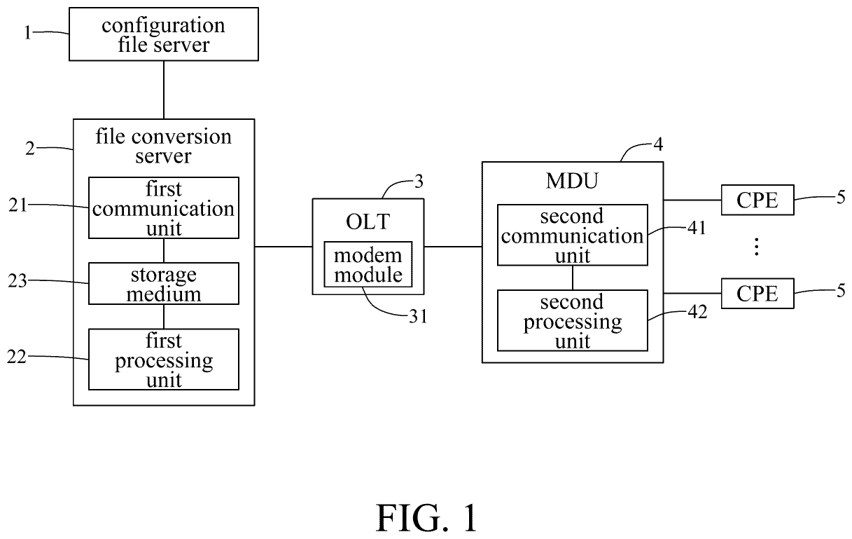

Referring to FIG. 1, according to an embodiment of the disclosure, a DOCSIS (Data Over Cable Service Interface Specification) Provisioning of EPON (Ethernet Passive Optical Network) (DPOE) system is provided. The DPoE system includes a configuration file server 1, a file conversion server 2, an optical line terminal (OLT) 3 and a plurality of multi-dwelling units (MDUs) 4 (in FIG. 1, only one of the MDUs 4 is illustrated for simplicity), where each of the MDUs 4 is electrically connected to a plurality of customer premise equipments (CPEs) 5 through, for example, a network cable. The file conversion server 2 is electrically connected to the configuration file server 1 through a communication network (e.g., a local area network (LAN) or the Internet). For example, the configuration file server 1 and the file conversion server 2 may be embodied as local servers or cloud servers, and may be located at different locations. The OLT 3 includes a modem module 31 (e.g., a Virtual Cable Modem (VCM)) and is electrically connected to the file conversion server 2 and the MDUs 4 through the communication network.

The file conversion server 2 includes a first communication unit 21 that is electrically connected to the communication network, a storage medium 22, and a first processing unit 23 that is electrically connected to the first communication unit 21 and the storage medium 22. The storage medium 22 stores a plurality of household identifications (IDs) that correspond respectively to the MDUs 4, and a plurality of user ID groups related respectively to the household IDs. Each of the user ID groups includes a plurality of user IDs that respectively correspond to the CPEs 5 which are associated with (i.e., electrically connected to) a corresponding one of the MDUs 4. In this embodiment, each of the household IDs is a media access control (MAC) address or a serial number of a corresponding one of the MDUs 4, and each of the user IDs included in the user ID group that is related to the household ID is a MAC address or a serial number of a corresponding one of the CPEs 5 that are associated with the corresponding one of the MDUs 4.

Each of the MDUs 4 includes a second communication unit 41 that is electrically connected to the communication network, and a second processing unit 42 electrically connected to the second communication unit 41.

In this embodiment, the storage medium 22 may be embodied using one or more computer-readable storage mediums such as hard disk drives, random access memory (RAM), read only memory (ROM), programmable ROM (PROM), flash memory, etc. Each of the first processing unit 23 and the second processing unit 42 may include, but is not limited to, one or more of a single core processor, a multi-core processor, a dual-core mobile processor, a microprocessor, a microcontroller, a digital signal processor (DSP), a field-programmable gate array (FPGA), an application specific integrated circuit (ASIC), a radio-frequency integrated circuit (RFIC), a system on a chip (SoC), etc.

In this embodiment, the first communication unit 21 may include one or more of a radio-frequency integrated circuit (RFIC), a short-range wireless communication module supporting a short-range wireless communication network using a wireless technology such as Bluetooth® and/or Wi-Fi, etc., a mobile communication module supporting telecommunication using Long-Term Evolution (LTE), the third generation (3G), the fourth generation (4G) or the fifth generation (5G) of the wireless mobile telecommunications technology, and a wired communication module that supports fiber-optic communication or Ethernet communication, or the like. The second communication unit 41 may be a fiber-optic module that is configured to communicate through fiber-optic communication.

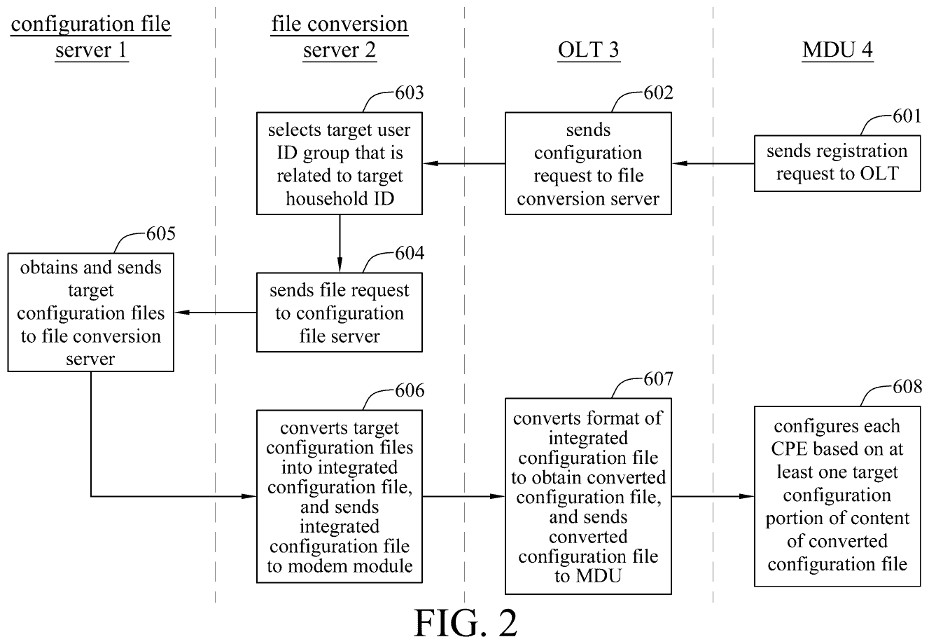

Further referring to FIG. 2, a method for configuring devices in the DPoE system includes steps 601 to 608. In the following description, since each of the MDUs 4 operates in a similar manner, only one of the MDUs 4 (hereinafter referred to as “target MDU”) is described in detail for simplicity.

In step 601, the second processing unit 42 of the target MDU 4 sends, through the second communication unit 41, a registration request that includes a target household ID corresponding to the target MDU 4 to the OLT 3.

In step 602, in response to receiving the registration request, the OLT 3 registers the target MDU 4 to the OLT 3, and after the target MDU 4 is registered to the OLT 3, the modem module 31 of the OLT 3 sends a configuration request that includes the target household ID to the file conversion server 2 through the first communication unit 21.

In step 603, in response to receiving, from the modem module 31 through the first communication unit 21, the configuration request that includes the target household ID corresponding to the target MDU 4, the first processing unit 23 of the file conversion server 2 selects, from among the user ID groups, a target user ID group that is related to one of the household IDs which conforms with the target household ID.

In step 604, the first processing unit 23 of the file conversion server 2 sends a file request that includes the target user ID group to the configuration file server 1 through the first communication unit 21.

In step 605, in response to receiving the file request from the file conversion server 2, the configuration file server 1 obtains and sends a plurality of target configuration files that correspond respectively to the user IDs included in the target user ID group to the file conversion server 2. Each of the target configuration files is related to a respective one of the CPEs 5 that are associated with the target MDU 4 (i.e., the CPEs 5 that are electrically connected to the target MDU 4), and is at least one of all user configurations that support DOCSIS, such as a quality of service (QOS) configuration, a network configuration, an internet protocol (IP) or port access restriction configuration, and/or a virtual area network configuration. It should be noted that the configuration file server 1 belongs to the cable operators, and pre-stores a plurality of configuration files that correspond respectively to a plurality of user IDs (including those user IDs that are stored in the storage medium 22).

In step 606, in response to receiving the target configuration files from the configuration file server 1 through the first communication unit 21, the first processing unit 23 of the file conversion server 2 converts the target configuration files into an integrated configuration file that is associated with the target MDU 4 and that includes contents of the target configuration files, and sends the integrated configuration file to the modem module 31.

In step 607, the modem module 31 converts a format of the integrated configuration file to obtain a converted configuration file, where a content of the converted configuration file includes the contents of the target configuration files in a different format, and sends the converted configuration file to the target MDU 4 through the second communication unit 41. Specifically, a format of the integrated configuration file is defined by the DOCSIS, and the modem module 31 converts the DOCSIS defined format of the integrated configuration file into an operations, administration and maintenance (OAM) format. That is to say, the converted configuration file is in the OAM format.

In step 608, in response to receiving the converted configuration file from the OLT 3 through the second communication unit 41, the second processing module 42 of the target MDU 4 configures the CPEs 5 that are associated with the target MDU 4 based on the converted configuration file. Specifically, for each of the CPEs 5 that are associated with the target MDU 4, the second processing module 42 of the target MDU 4 configures the CPE 5 based on at least one target configuration portion of the content of the converted configuration file, where the at least one target configuration portion corresponds to the content of the target configuration file that corresponds to the user ID of the CPE 5.

It should be noted that, in some circumstances, after receiving the integrated configuration file, the modem module 31 may directly configure itself based on a portion of the content of the converted configuration file. Then, the modem module 31 converts a format of the remaining portion of the content of the integrated configuration file to obtain the converted configuration file, and sends the converted configuration file to the target MDU 4. The second processing module 42 of the target MDU 4 then configures each of the CPEs 5 that are associated with the target MDU 4 based on the remaining portion (i.e., the at least one target configuration portion) of the content of the integrated configuration file that is included in the converted configuration file.

In summary, according to the disclosure, the file conversion server 2 receives the target household ID from the target MDU 4, selects the target user ID group that is related to the target household ID, and obtains the target configuration files that correspond respectively to the user IDs included in the target user ID group from the configuration file server 1. Then, the target MDU 4 is able to configure each of the CPEs 5 that are associated with the target MDU 4 based on the target configuration files. As such, the configuration files respectively related to the CPEs 5 may be obtained from the configuration file server 1 and be provided simultaneously to the target MDU 4 for configuring the CPEs 5 that are associated with the target MDU 4.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method for configuring devices in a DOCSIS (Data Over Cable Service Interface Specification) Provisioning of EPON (Ethernet Passive Optical Network) (DPoE) system, the method to be implemented by a file conversion server that stores a plurality of household identifications (IDs) corresponding respectively to a plurality of multi-dwelling units (MDUs), and a plurality of user ID groups related respectively to the plurality of household IDs, each of the plurality of user ID groups including at least one user ID that respectively corresponds to at least one customer premise equipment (CPE) which is associated with one of the MDUs, the method comprising:
in response to receiving, from a modem module, a configuration request that includes a target household ID corresponding to a target MDU from among the plurality of MDUs, selecting, from among the plurality of user ID groups, a target user ID group that is related to one of the plurality of household IDs which conforms with the target household ID;
sending a file request that includes the target user ID group to a configuration file server, where the configuration file server, in response to receipt of the file request, obtains and sends at least one target configuration file that corresponds respectively to the at least one user ID included in the target user ID group to the file conversion server; and
in response to receiving the at least one target configuration file from the configuration file server, converting the at least one target configuration file into an integrated configuration file that is associated with the target MDU and that includes a content of the at least one target configuration file, and sending the integrated configuration file to the modem module, the modem module, in response to receipt of the integrated configuration file, converting a format of the integrated configuration file to obtain a converted configuration file, where a content of the converted configuration file includes the content of the at least one target configuration file in a different format, and then sending the converted configuration file to the target MDU for the target MDU to configure, based on at least one target configuration portion of the content of the converted configuration file, at least one CPE that is associated with the target MDU.

2. The method as claimed in claim 1, wherein each of the at least one user ID included in the target user ID group is one of a media access control (MAC) address and a serial number of a corresponding one of the at least one CPE associated with the target MDU.

3. The method as claimed in claim 1, wherein the at least one target configuration file is related to the at least one CPE 5, and is at least one of all user configurations that support DOCSIS.

4. A method for configuring devices in a DOCSIS (Data Over Cable Service Interface Specification) Provisioning of EPON (Ethernet Passive Optical Network) (DPoE) system, the method to be implemented by a multi-dwelling unit (MDU) and comprising:
sending a registration request that includes a target household identification (ID) corresponding to the MDU to an optical line terminal (OLT), a modem module of the OLT, in response to receipt of the registration request, sending a configuration request that includes the target household ID to a file conversion server, such that the file conversion server obtains, from a configuration file server, at least one target configuration file according to a target user ID group that is related to the target household ID and that includes at least one user ID corresponding respectively to the at least one target configuration file, and sends an integrated configuration file that includes a content of the at least one target configuration file to the modem module, the modem module further, in response to receipt of the integrated configuration file, converting a format of the integrated configuration file to obtain a converted configuration file, where a content of the converted configuration file includes the content of the at least one target configuration file in a different format, and then sending the converted configuration file to the MDU; and
in response to receiving the converted configuration file, configuring, based on at least one target configuration portion of the content of the converted configuration file, at least one customer premise equipment (CPE) that is associated with the MDU.

5. A file conversion server for configuring devices in a DPoE system, comprising:
a storage medium that stores a plurality of household identifications (IDs) corresponding respectively to a plurality of multi-dwelling units (MDUs), and a plurality of user ID groups related respectively to the plurality of household IDs, each of the plurality of user ID groups including at least one user ID that respectively corresponds to at least one customer premise equipment (CPE) which is associated with one of the plurality of MDUs;
a processing unit that is electrically connected to said storage medium, and that is configured to implement the method of claim 1.

6. The file conversion server as claimed in claim 5, wherein each of the at least one user ID included in the target user ID group is one of a media access control (MAC) address and a serial number of a corresponding one of the at least one CPE associated with the target MDU.

7. The file conversion server as claimed in claim 5, wherein the at least one target configuration file is related to the at least one CPE 5, and is at least one of all user configurations that support DOCSIS.

8. The file conversion server as claimed in claim 5, further comprising a communication unit that is electrically connected to said processing unit,
wherein said processing unit is configured to receive the configuration request from the modem module through said communication unit, send the file request to the configuration file server through said communication unit, receive the at least one target configuration file from the configuration file server through said communication unit, and send the integrated configuration file to the modem module through said communication unit.

9. A multi-dwelling unit (MDU) for configuring devices in a DPoE system, comprising a processing unit that is configured to implement the method of claim 4.

10. The MDU as claimed in claim 9, further comprising a communication unit that is electrically connected to said processing unit,
wherein said processing unit is configured to send the registration request to the OLT through said communication unit, and receive the converted configuration file from the modem module through said communication unit.
